(19) United States
(12) Patent Application Publication
(10) Pub. No.: US 2006/0064713 A1
(43) Pub. Date: Mar. 23, 2006

(54) Disc cartridge, and information recording reproducing device using the disc cartridge

(75) Inventor: Shinnosuke Torii, Kanagawa-ken (JP)

Correspondence Address: FITZPATRICK CELLA HARPER & SCINTO, 30 ROCKEFELLER PLAZA, NEW YORK, NY, 10112, US

(73) Assignee: CONON KABUSHIKI KAISHA, Tokyo (JP)

(21) Appl. No.: 10/535,669

(22) PCT Filed: Jun. 25, 2004
(86) PCT No.: PCT/JP04/09382

§ 371 Date: May 19, 2005

(30) Foreign Application Priority Data
Jul. 9, 2003 (JP) 2003-194310

(51) Int. Cl. G11B 23/03

(52) U.S. Cl. 720/725

(57) ABSTRACT

A thin bridge part provided in an aperture of a disc cartridge is located farther from a optical pickup than a surface of a disc, which is the surface to be irradiated with a light beam in a state in which the disc cartridge is mounted to the information recording/reproducing device. A optical pickup is retracted into a position opposite to an end surface of the thin bridge part at the time of mounting and removing the disc. According to the constitution, a small-sized information recording/reproducing device is realized while preventing an objective lens from colliding against a disc or a cartridge case at the time of mounting and removing the disc.

### TECHNICAL FIELD

The present invention relates to a disc cartridge for housing a disc-like recording medium, and to an information recording/reproducing device for recording information on and/or reproducing information from the recording medium.

### BACKGROUND ART

FIG. 4 is a schematic perspective view of a conventional disc cartridge. FIGS. 5A to 5C are a front view, a side view, and a cross sectional view, respectively, of the disc cartridge.

In FIG. 4 and FIGS. 5A to 5C, reference numeral 1 denotes a disc-like recording medium (hereinafter referred to as disc); 2, an attraction plate that is adhered to the disc 1; 3, a first half which is a side to be irradiated with a light beam; 4, a second half which is opposed to the first half 3; 5, an aperture formed in the first half 3 from an inner peripheral side to an outer peripheral side of the disc 1 for irradiation with the light beam; 6, a thin bridge part provided in the aperture 5 which is thinner than a cartridge case 11; 7, a shutter for closing the aperture 5 and the thin bridge part 6; 7a, a guide part formed by bending an end portion of the shutter 7 into a substantial U-shape in cross section; 8, a sliding surface for the shutter 7 which is formed in a concave-shape on the first half 3; and 9, a guide groove formed in the second half 4 into which the guide part 7a of the shutter 7 is inserted. With such a construction, the disc 1 and the attraction plate 2 are housed in a disc cartridge 10 as shown in FIG. 4 and FIGS. 5A to 5C. In the disc cartridge 10, the disc 1 and the attraction plate 2 are disposed to be rotatable within the disc cartridge case 11 that is composed of the first half 3 and the second half 4. The shutter 7 for closing the aperture 5 and the thin bridge part 6 can be slid on the sliding surface 8 with the guide part 7a inserted into the guide groove 9.

Referring to FIGS. 6, 7, and 8A to 8C, detailed description is made of an information recording/reproducing device with the disc cartridge being mounted thereto. FIG. 6 is a schematic perspective view of the information recording/reproducing device, and FIG. 7 is a schematic plan view of the information recording/reproducing device shown in FIG. 6 from which a cartridge holder to be described later and a pivot of the cartridge holder are removed. FIG. 8A is a front view of the information recording/reproducing device shown in FIG. 7 with the disc cartridge being mounted thereto, FIG. 8B is a side view thereof, and FIG. 8C is a cross sectional view taken along the line 8C-8C of FIG. 8A.

An information recording/reproducing device 21 is composed of a chassis 22 serving as a structural base, a spindle motor 23 that is provided to the chassis 22 and onto which the disc 1 is mounted and rotated, a optical pickup 24, an objective lens 25 that is disposed on the optical pickup 24 and serves to emit a light beam, a feed motor 26 with a lead screw 28 which is provided to the chassis 22 and serves to move the optical pickup 25 in a radial direction of the disc 1, a guide shaft 27 for supporting the optical pickup 24, a cartridge holder 29 for rotatably supporting the disc cartridge 10, a pivot 30 of the cartridge holder 29 which is provided to the chassis 22, a lead screw bearing 31 that is provided to the chassis 22 and serves to support the lead screw 28, and a guide shaft bearing 32 that is provided to the chassis 22 and serves to support the guide shaft 27.

The disc cartridge 10 is inserted into the cartridge holder 29 of the information recording/reproducing device 21 while being held by a cartridge support portion 29a formed at an end portion of the cartridge holder 29 in a substantial U-shape. At the same time, the shutter 7 is slid along the guide groove 9 by a not-shown shutter opening and closing mechanism (which is generally provided on the side face of the shutter 7, that is, to the right side of the shutter 7 in FIG. 8A), thereby opening the aperture 5 of the first half 3. Then, the cartridge holder 29 is pivoted (manually) toward the chassis 22 about the pivot 30 serving as its rotation center, while holding the disc cartridge 10. This causes the spindle motor 23 to enter the disc cartridge 10 through the aperture 5, mounting a center hole 1a of the disc 1 onto a turntable surface 23a of the spindle motor 23. Note that in this conventional example, an attraction magnet (not shown) provided to the spindle motor 23 attracts the attraction plate 2 to thereby mount the disc 1 thereon. Then, the disc 1, which is rotated by the spindle motor 23, is irradiated with a light beam emitted from the objective lens 25 of the optical pickup 24. The lead screw 28 formed integrally with a rotation shaft of the feed motor 26 and the optical pickup 24 are engaged with each other by a not-shown rack. By converting the rotation of the lead screw 28 into the translation motion, the optical pickup 24 is moved in a radial direction of the disc 1 with the guide shaft 27 used as a guide. Thus, the information recording/reproducing device 21 records information on and/or reproduces information from the disc 1.

In recent years, however, with the increase of the recording density, it is required to minimize a light spot formed on the disc, which makes the wavelength of the light source shorter, and makes an NA of the objective lens higher (NA of 0.8 or higher). When the NA of the objective lens becomes higher, the working distance (hereinafter referred to as WD) tends to be reduced. In a recent Blu-ray Disc, a two-group lens is used to realize NA=0.85, while the WD is only about 0.14 mm. With such a small WD, the disc surface may collide against the objective lens when the disc is mounted or removed, which leads to the following significant problems. If the collision causes a flaw on the disc surface, the recorded data may be lost or may not be reproduced properly. If the collision causes a flaw on the objective lens, accurate recording/reproducing may be difficult.

In a conventional information recording/reproducing device where a simple disc is used with the disc being not housed in a cartridge case, the optical pickup is moved toward the outer periphery of the disc, as viewed from the perpendicular direction of the disc surface, so that the optical pickup may be retracted into a position where the disc surface does not overlap the objective lens to thereby avoid the collision. With such a construction, however, there has to be a space for the optical pickup to be retracted, which increases the size of the device.

Further, in the case where the above disc is used as a portable device, it is preferable that the disc be housed in a cartridge case so that the recorded information may be well preserved. In the conventional disc cartridge described above, however, the problems caused by the collision are not taken into consideration. Therefore, with a side face (denoted by 3a in FIG. 8C) of the first half being an obstacle, it is difficult to move the optical pickup which has an objective lens with a shorter WD, toward the outer periphery of the disc to the outside of the cartridge.

### DISCLOSURE OF INVENTION

The present invention has been made in order to solve the above problems, and an object of the present invention is to realize a small-sized information recording/reproducing device while preventing an objective lens from colliding against a disc at the time of mounting and removing the disc.

According to an aspect of the present invention, a disc cartridge includes: a case main body having a housing part for housing a recording medium; an aperture that allows a light beam to enter from a optical pickup that is provided to at least one principle plane of the case main body; a thin bridge part provided to the aperture, which is thinner than a cartridge case; and a shutter for opening and closing the aperture, in which the thin bridge part is disposed at a position farther from the optical pickup than a surface of the recording medium which is on a side to be irradiated with the light beam in a state in which the disc cartridge is mounted to an information recording/reproducing device.

According to another aspect of the present invention, an information recording/reproducing device for at least one of recording information on and reproducing information from a disc-like recording medium housed in the disc cartridge according to the aspect of the invention, includes: a turntable for rotating the recording medium; a optical pickup that emits a light beam to the recording medium so as to at least one of record and reproduce the information, and which moves to/retracts from the aperture of the disc cartridge; and a mechanism for moving the optical pickup in an in-plane direction of the recording medium, in which in at least one of a case where the recording medium is to be mounted to the turntable together with the disc cartridge, and a case where the recording medium is to be removed from the turntable together with the disc cartridge, the optical pickup is retracted into a position opposite to the thin bridge part of the disc cartridge.

### BRIEF DESCRIPTION OF THE DRAWINGS

FIG. 1 is a schematic perspective view of a disc cartridge according to the present invention;

FIGS. 2A, 2B and 2C are a front view, a side view, and a cross sectional view, respectively, of the disc cartridge shown in FIG. 1;

FIGS. 3A, 3B and 3C are a front view, a side view, and a cross sectional view, respectively, of an information recording/reproducing device with the disc cartridge shown in FIG. 1 being mounted thereto;

FIG. 4 is a schematic perspective view of a conventional disc cartridge;

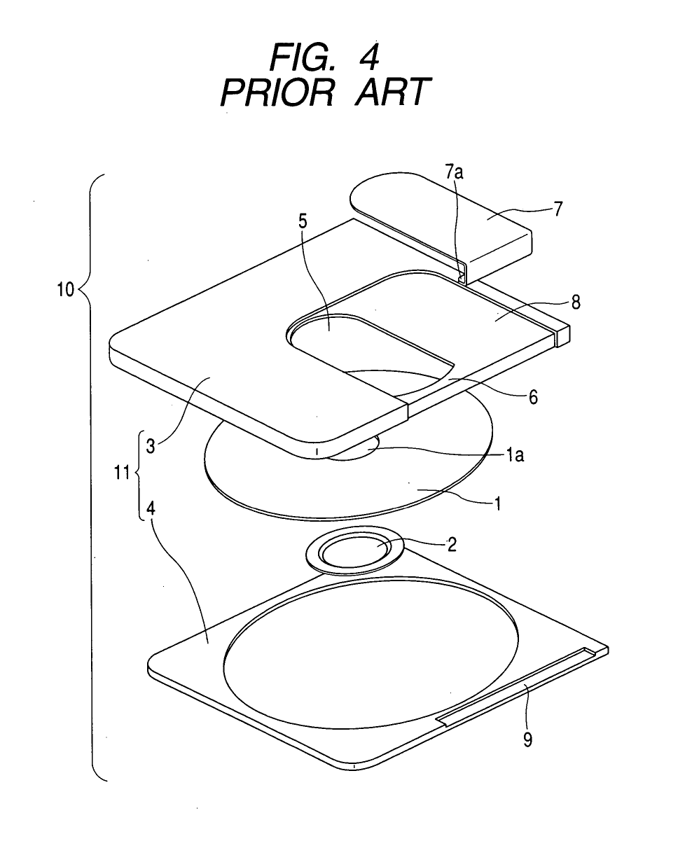

FIGS. 5A, 5B and 5C are a front view, a side view, and a cross sectional view, respectively, of the disc cartridge shown in FIG. 4;

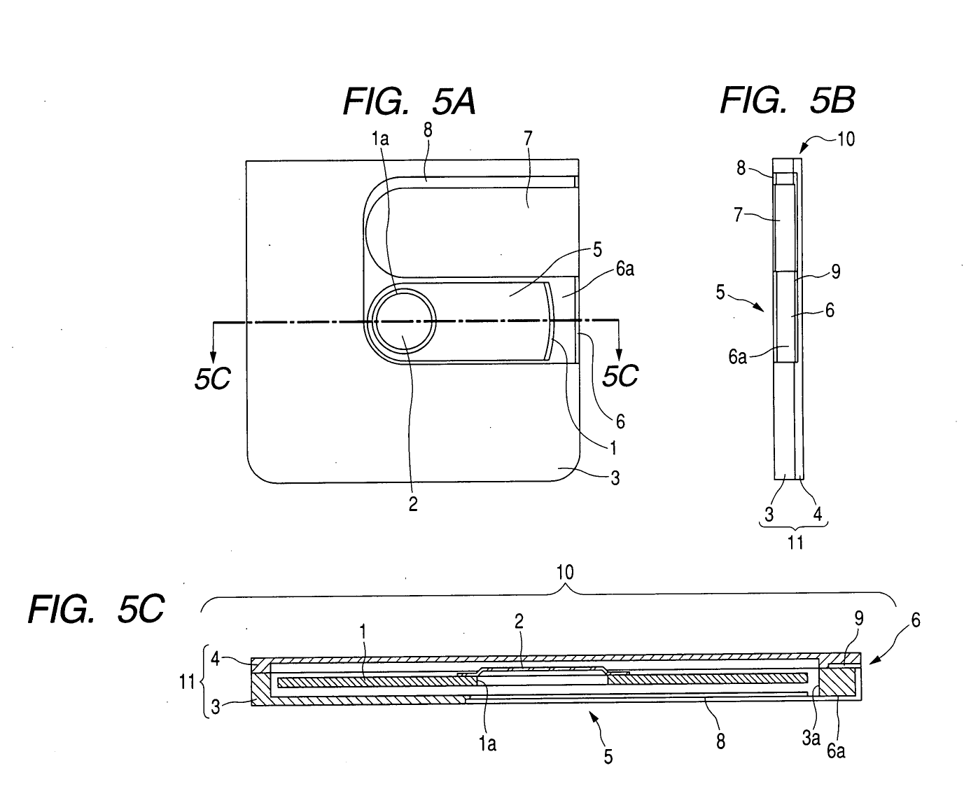

FIG. 6 is a schematic perspective view of a conventional information recording/reproducing device;

FIG. 7 is a schematic plan view of the conventional information recording/reproducing device; and

FIGS. 8A, 8B and 8C are a front view, a side view, and a cross sectional view, respectively, of the conventional information recording/reproducing device shown in FIGS. 6 and 7 with the disc cartridge shown in FIG. 4 being mounted thereto.

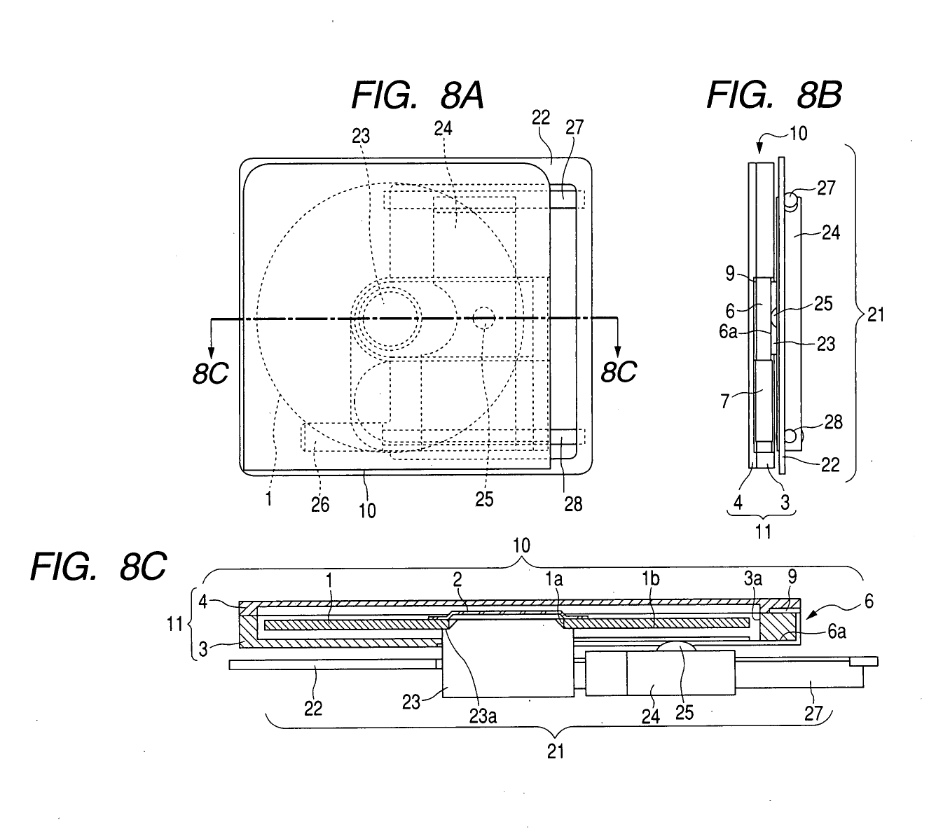

### BEST MODE FOR CARRYING OUT THE INVENTION

Hereinafter, an embodiment of the present invention will be described in detail with reference to the drawings.

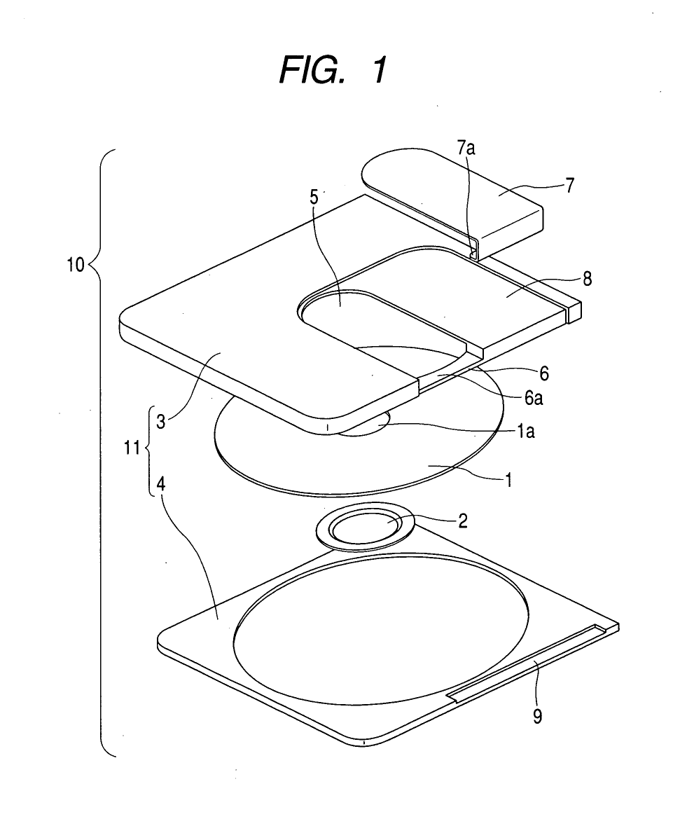

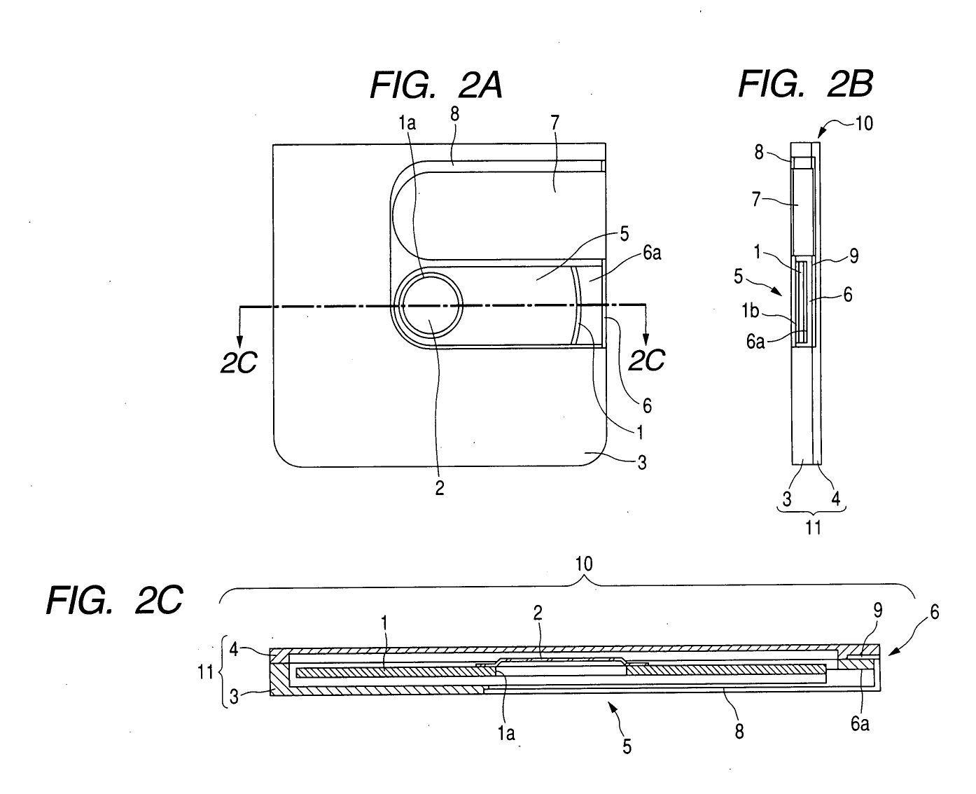

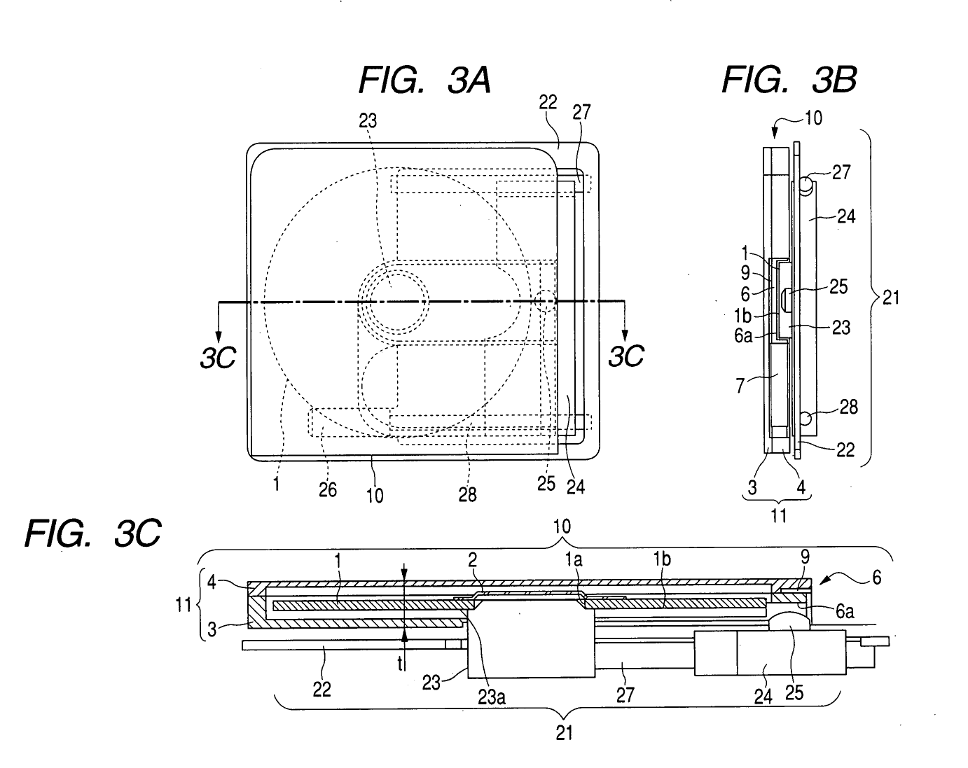

FIG. 1 is a schematic perspective view showing a construction of a disc cartridge according to an embodiment of the present invention, as viewed from a side to be irradiated with a light beam. FIGS. 2A to 2C are a front view, a side view, and a cross sectional view taken along the line 2C-2C of FIG. 2A, respectively, of the disc cartridge. Note that in this embodiment, the basic structure of the disc cartridge is similar to that of the conventional one. What is characteristic about the disc cartridge according to the present invention is that as shown in FIGS. 2C and 3C, a surface 6a of a thin bridge part 6 of a first half 3 is displaced to a second half 4 side, which is the side opposite to the side to be irradiated with a light beam from a optical pickup.

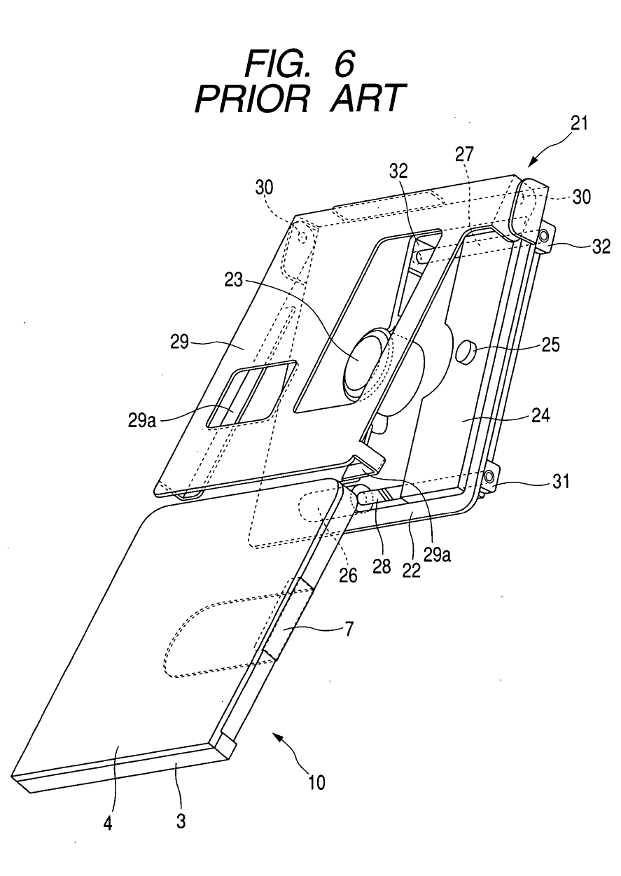

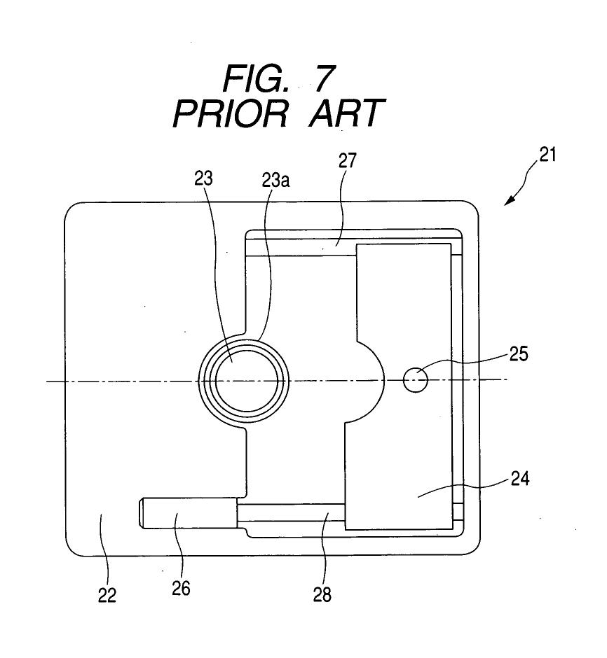

Next, referring to FIGS. 3A to 3C, description is made of an information recording/reproducing device with the disc cartridge being mounted thereto. Note that the information recording/reproducing device of this embodiment is similar to the conventional one shown in FIGS. 6 and 7, and therefore a detailed description thereof is omitted. FIG. 3A is a front view of the information recording/reproducing device with the disc cartridge being mounted thereto, FIG. 3B is a side view thereof, and FIG. 3C is a cross sectional view taken along the line 3C-3C of FIG. 3A.

According to the present invention, in a state in which a disc 1 is mounted onto a spindle motor 23, the surface 6a of the thin bridge part 6 of the first half 3 is located farther from a optical pickup 24 than a surface 1b (which is a surface to be irradiated with a light beam) of the disc 1 on a side of the first half 3. It is preferable that the distance between the surface 1b of the disc 1 and the surface 6a of the thin bridge part 6 be no less than a half of a thickness d of the disc 1. Note that in a disc cartridge 10 of this embodiment, the center in the thickness direction of the disc 1 and the center in the thickness direction of the disc cartridge 10 coincide with each other in a state in which the disc 1 is mounted onto the spindle motor 23. When the thickness of the disc cartridge 10 is represented by t (see FIG. 3C), the distance from a principle plane of the disc cartridge 10 on the first half side to the surface 1b of the disc 1 on the first half side is (t−d)/2. The distance from the principle plane of the disc cartridge 10 on the first half side to the surface 6a of the thin bridge part 6 is t/2.

In this embodiment, as shown in FIG. 3C, an objective lens 25 is disposed at a position opposite to the surface 6a of the thin bridge part 6, thereby increasing a clearance above the objective lens (in the direction of the second half 4) by d/2. By retracting the optical pickup 24 (more specifically, the objective lens 25) into the position opposite to the surface 6a of the thin bridge part 6, where there is more room above the objective lens 25 than the surface 1b of the disc 1 on the first half side at the time of mounting/removing the disc 1, not only is it possible to prevent the collision of the objective lens 25 against the disc 1, but also the collision of the objective lens 25 against a cartridge case 11 can be prevented. Further, the movement of the optical pickup 24 can be reduced, and the size of the device can be decreased.

Note that the present invention is not limited by this embodiment. It is possible, for example, to further increase the clearance above the objective lens by increasing the displacement of the surface 6a of the thin bridge part 6 form the surface 1b of the disc 1, making the displacement larger than d/2.

Further, even when the disc cartridge is made thinner and the above displacement is smaller than d/2 due to the design, it is still possible to obtain the effect of the present invention by making the surface 6a of the thin bridge part 6 farther from the optical pickup 24 than the surface 1b of the disc 1.

Further, in the present invention, the objective lens 25 is disposed at approximately the center of the optical pickup 24 in the radial direction of the disc. It is possible, however, to reduce the protruding amount of the optical pickup 24 from the disc cartridge 10 as shown, for example, in FIG. 3A, by placing the objective lens 25 in the vicinity of the side face at the periphery of the optical pickup 24, in the case where the optical pickup 24 is disposed at a position opposite to the thin bridge part 6 so as to prevent collision.

Further, although not shown in the drawings, a shutter opening and closing mechanism is provided to the shutter side of the disc cartridge 10. Therefore, when the optical pickup 24 is moved to the retracting position of this embodiment, it is actually possible to structure the device with almost no change in size of a chassis 22. Therefore, it is possible to prevent the collision without increasing the size of an information recording/reproducing device 21.

Further, in this embodiment, the thin bridge part 6 is structured only by the first half 3. However, the first half 3 may be cut out and the second half 4 may be used to structure the thin bridge part 6. It is also possible to form the side face of the disc cartridge 10 by a different member.

Further, in the present invention, it is the objective lens 25 that is described as a member that may cause collision. However, if an objective lens holder (not shown) that fixes the objective lens, an objective lens actuator (not shown) that actuates the objective lens 25, or the like protrude more to the disc 1 side than the objective lens 25, it is possible to prevent collision by disposing the protruding portion at a position opposite to the thin bridge part 6.

1-2. (canceled)

3. An information recording/reproducing device for at least one of recording information on and reproducing information from a disc-like recording medium housed in the disc cartridge, with the disc cartridge comprising a case main body having a housing part for housing the recording medium, an aperture that allows a light beam to enter from an optical pickup that is provided to at least one principle plane of the case main body, a thin bridge part provided to the aperture, which is thinner than a cartridge case, and a shutter for opening and closing the aperture, wherein the thin bridge part is disposed at a position farther from the optical pickup than a surface of the recording medium which is on a state in which the disc cartridge is mounted to an information recording/reproducing device, the information recording/reproducing device comprising:
a turntable for rotating the recording medium;
an optical pickup that emits a light beam to the recording medium so as to at least one of record and reproduce the information, and which moves to/retracts from the aperture of the disc cartridge; and
a mechanism for moving the optical pickup in an in-plane direction of the recording medium,
wherein in at least one of a case where the recording medium is to be mounted to the turntable, and a case where the recording medium is to be removed from the turntable, the optical pickup is retracted into a position opposite to the thin bridge part of the disc cartridge.
